(19) United States
(12) Patent Application Publication
(10) Pub. No.: US 2015/0277646 A1
(43) Pub. Date: Oct. 1, 2015

(54) PRESSURE-SENSITIVE ELEMENT, METHOD OF PRODUCING THE PRESSURE-SENSITIVE ELEMENT, TOUCH PANEL EQUIPPED WITH THE PRESSURE-SENSITIVE ELEMENT, AND METHOD OF PRODUCING THE PRESSURE-SENSITIVE ELEMENT

(71) Applicant: Panasonic Intellectual Property Management Co., Ltd., Osaka (JP)

(72) Inventors: TETSUYOSHI OGURA, Osaka (JP); AKI YAZAWA, Hyogo (JP)

(21) Appl. No.: 14/551,000

(22) Filed: Nov. 22, 2014

(30) Foreign Application Priority Data
Mar. 31, 2014 (JP) 2014-073523

(51) Int. Cl. G06F 3/041; G06F 1/16

(52) U.S. Cl. CPC G06F 3/0414; G06F 1/16; G06F 2203/04103

(57) ABSTRACT

A pressure-sensitive element of the present disclosure includes a substrate, a conductive component, an elastic electrode portion, and an electrode supporting component. The conductive component extends from the substrate. The elastic electrode portion opposes a tip of the conductive component. The electrode supporting component opposes the substrate with the conductive component and the elastic electrode portion interposed therebetween, supports the elastic electrode portion, and has flexibility. In the pressure-sensitive element, the conductive component has a higher elastic modulus than that of the elastic electrode portion. In the pressure-sensitive element, the elastic electrode portion has a flat surface which opposes the conductive component and which is capable of being brought into contact with the conductive component.

This Application claims priority to Japanese Patent Application. No. 2014-073523, filed on Mar. 31, 2014, the contents of which are hereby incorporated by reference.

### BACKGROUND

1. Technical Field

The technical field relates to a pressure-sensitive element and a method of producing the pressure-sensitive element. The technical field also relates to a touch panel equipped with the pressure-sensitive element and a method of producing the touch panel.

2. Description of the Related Art

Nowadays, various electronic devices equipped with touch panels such as smartphones and car navigation systems are increasingly sophisticated and diversified. Along with this trend, as a structural element of these electronic devices, a pressure-sensitive element, which can accurately and reliably detects a change in the pressing force, is demanded.

For example, a pressure-sensitive element described in Japanese Unexamined Patent Application Publication No. 2008-311208 includes a substrate, a pressure-sensitive conductive sheet, and a plurality of electrodes. The pressure-sensitive conductive sheet opposes and is spaced apart from the substrate. The plurality of electrodes, which are formed of silver, carbon, copper, or the like, are provided on the substrate so as to be interposed between the substrate and the pressure-sensitive conductive sheet. The electrodes are connected to circuitry of an electronic device through leads or the like. The pressure-sensitive conductive sheet includes a conductive layer and particles of, for example, urethane or glass. The elastic conductive layer is brought into contact with the electrodes. The particles, the particle size of which is several ten to hundred μm, are dispersed in the conductive layer. The surface of the conductive layer opposite the electrodes has irregular protrusions and recesses formed by the plurality of particles dispersed in the conductive layer.

In the pressure-sensitive element described in Japanese Unexamined Patent Application Publication No. 2008-311208, when the pressure-sensitive conductive sheet is pressed, the surface, which has the protrusions and recesses, of the conductive layer of the pressure-sensitive conductive sheet is brought into contact with the plurality of electrodes disposed at the substrate. This causes the plurality of electrodes to be electrically connected to one another through the conductive layer. When the pressure-sensitive conductive sheet is further pressed, the conductive layer is deformed. This causes a contact area between the conductive layer and the electrodes to be increased, and accordingly, the resistance between the electrodes is reduced. In accordance with a change in this resistance, the pressure-sensitive element according to the Japanese Unexamined Patent Application Publication No. 2008-311208 detects the pressing force acting on the pressure-sensitive conductive sheet.

As another example, a pressure-sensitive element described in Japanese Unexamined Patent Application Publication No. 2012-208038 includes a first insulating film, a first electrode, a conductive elastic body, a second electrode, and a second insulating film. The first electrode is provided on the first insulating film. The conductive elastic body is provided on the first electrode and has a plurality of protrusions having a truncated polygonal pyramid shape (for example, truncated quadrangular pyramid shape). The second electrode opposes the tips of the protrusions of the conductive elastic body. The second insulating film supports the second electrode. The first and second electrodes are formed of copper, silver, gold, stainless steel, or the like. When the second insulating film is pressed, the first electrode and the second electrode are electrically connected to each other through the conductive elastic body.

### SUMMARY

The present disclosure reduces variation of change in the resistances corresponding to a change in a pressing force and improves the durability of a pressure-sensitive element.

According to an aspect of the present disclosure, a pressure-sensitive element includes a substrate, a conductive component, an elastic electrode portion, and an electrode supporting component. The conductive component extends from the substrate. The elastic electrode portion opposes a tip of the conductive component. The electrode supporting component opposes the substrate with the conductive component and the elastic electrode portion interposed therebetween, supports the elastic electrode portion, and has flexibility. In the pressure-sensitive element, the conductive component has a higher elastic modulus than that of the elastic electrode portion. In the pressure-sensitive element, the elastic electrode portion has a flat surface which opposes the conductive component and which is capable of being brought into contact with the conductive component.

According to the above-described aspect, variation of change in the resistance corresponding to a change in the pressing force can be reduced, and the durability of the pressure-sensitive element can be improved.

### BRIEF DESCRIPTION OF THE DRAWINGS

FIG. 1 is an exploded perspective view of part of a pressure-sensitive element, according to a first embodiment of the present disclosure.

FIG. 2 is a schematic sectional view of the pressure-sensitive element according to the first embodiment of the present disclosure.

FIG. 3 is a sectional view of an example of the structure of conductive components according to the first embodiment.

FIG. 4 is a sectional view of another example of the structure of the conductive components according to the first embodiment.

FIG. 5 illustrates an example of an elastic electrode portion according to the first embodiment.

FIG. 6 illustrates another example of the elastic electrode portion according to the first embodiment.

FIG. 7 illustrates yet another example of the elastic electrode portion according to the first embodiment.

FIG. 8 illustrates yet another example of the elastic electrode portion according to the first embodiment.

FIG. 9 is a schematic sectional view of the pressure-sensitive element according to the first embodiment to which a pressing force is applied.

FIG. 10 is a sectional view of an example of the structure of an elastic electrode portion according to the first embodiment.

FIG. 11 is a sectional view of another example of the structure of the elastic electrode portion according to the first embodiment.

FIG. 12 illustrates changes in the electrical resistance in a plurality of the pressure-sensitive elements, which include the elastic electrode portions having different elastic moduli, corresponding to a change in the pressing force.

FIG. 13 illustrates a change in the electrical resistance corresponding to a change in the pressing force acting on the pressure-sensitive element.

FIG. 14 illustrates an example of the shape of the conductive components according to the first embodiment.

FIG. 15A is a schematic sectional view of a pressure sensitive element according to a second embodiment of the present disclosure.

FIG. 15B is a schematic sectional view of the pressure-sensitive element according to the second embodiment to which a relatively small pressing force is applied.

FIG. 15C is a schematic sectional view of the pressure-sensitive element according to the second embodiment to which a relatively large pressing force is applied.

FIG. 16A is a schematic sectional view of a pressure sensitive element according to a third embodiment of the present disclosure.

FIG. 16B is a schematic sectional view of the pressure-sensitive element according to the third embodiment to which a relatively small pressing force is applied.

FIG. 16C is a schematic sectional view of the pressure-sensitive element according to the third embodiment to which a relatively large pressing force is applied.

FIG. 17 is a perspective view of part of a pressure-sensitive element according to a fourth embodiment of the present disclosure.

FIG. 18 is a perspective view of another example of a conductive component according to the fourth embodiment.

FIG. 19 is a schematic sectional view of a touch panel according to an embodiment of the present disclosure.

FIG. 20A is a sectional view illustrating a step of a method of producing the pressure-sensitive element according to the embodiments of the present disclosure.

FIG. 20B is a sectional view illustrating a step that follows the step illustrated in FIG. 20A.

FIG. 20C is a sectional view illustrating a step that follows the step illustrated in FIG. 20B.

FIG. 20D is a sectional view illustrating a step that follows the step illustrated in FIG. 20C.

FIG. 21 is a perspective view of part of the pressure-sensitive element according to the first embodiment of the present disclosure.

FIG. 22 is a perspective view of part of the pressure-sensitive element according to the first embodiment of the present disclosure.

FIG. 23 illustrates yet another example of the elastic electrode portion according to the first embodiment.

### DETAILED DESCRIPTION

### Findings Underlying Present Disclosure

Before describing forms of implementation of the present disclosure, what the disclosers have discussed is initially described.

For example, in the case of a pressure-sensitive element described in Japanese Unexamined Patent. Application Publication No. 2008-311208, particles of urethane, glass, or the like having different particle sizes are irregularly contained in a conductive layer. Thus, the surface of the conductive layer opposing electrodes has irregular protrusions and recesses. Accordingly, among a plurality of pressure-sensitive elements, the conductive, layers are in contact with the plurality of electrodes in a non-uniform state. As a result, it has been found that, even when the pressing forces acting on the plurality of pressure-sensitive elements are uniformly changed, change in the resistances between the plurality of electrodes varies from pressure-sensitive element to pressure-sensitive element.

In a pressure-sensitive element, described in Japanese Unexamined Patent Application Publication No. 2012-208038, a plurality of protrusions, which have the same shape, of an conductive elastic body are brought into contact with a planar portion of a second electrode, thereby reducing variation of change in the resistance between the electrodes. However, when the protrusions of the conductive elastic body are repeatedly deformed by repeatedly pressing the pressure-sensitive element, repeated stress is concentrated in the bottoms of the protrusions. This may cause cracks in the bottom portions, and the conductive elastic body may partially break due to growth of the cracks. Thus, the disclosers have found that the pressure-sensitive element described in Japanese Unexamined. Patent Application Publication No. 2012-208038 may have a low durability.

The disclosers thought of disclosure of forms of implementation according to the present disclosure on the basis of the above-described findings.

Hereafter, a pressure-sensitive element according to embodiments of the present disclosure will be described with reference to the drawings.

### Description of Present Disclosure

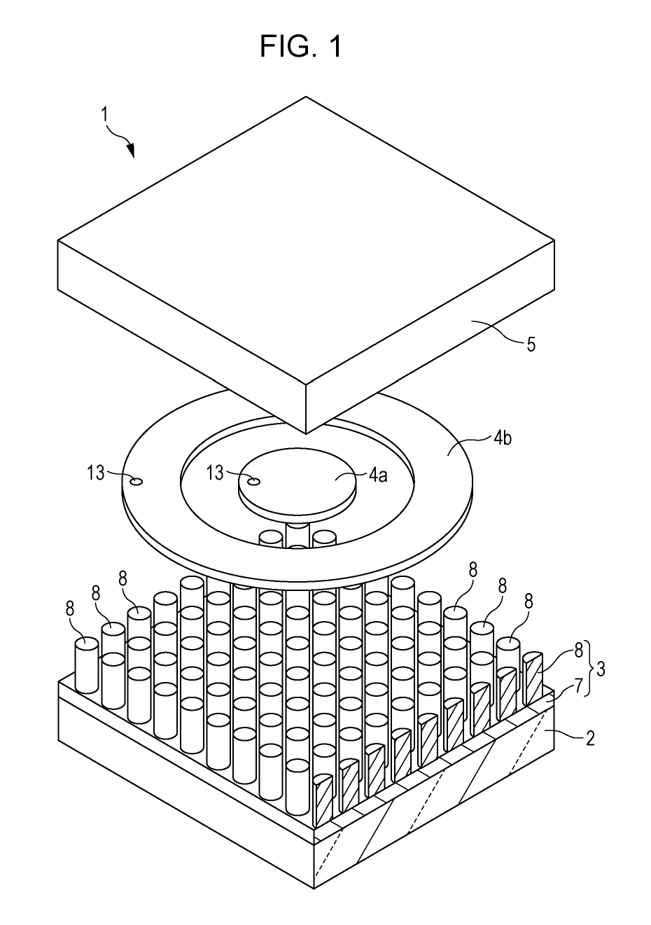

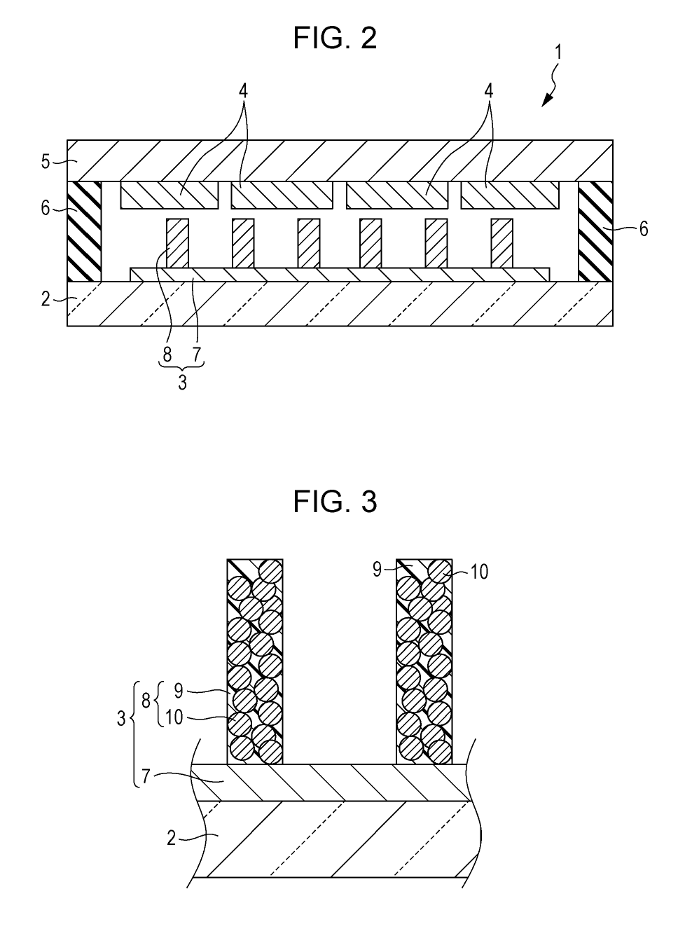

FIG. 1 is an exploded perspective view of part of a pressure-sensitive element according to a first embodiment of the present disclosure. FIG. 2 is a sectional view of the pressure-sensitive element according to the first embodiment of the present disclosure.

As illustrated in FIGS. 1 and 2, a pressure-sensitive element 1 includes a substrate 2, a conductive structure 3, and an electrode supporting component 5. The conductive structure is provided on the substrate 2. The electrode supporting component 5 opposes the substrate 2 with the conductive structure 3 interposed therebetween.

The electrode supporting component 5 is a flexible plate-shaped elastic member. An elastic electrode portion 4 is provided at the electrode supporting component 5. The elastic electrode portion 4 is supported by the electrode supporting component 5 such that the elastic electrode portion 4 opposes the tips of the conductive structure 3. The elastic electrode portion 4 has a flat surface that opposes and is to be brought into contact with conductive components 8 of the conductive structure 3, which will be described later. The reason for this will be described later.

The electrode supporting component 5 opposes the substrate 2 so as to be parallel to and spaced apart from the substrate 2 with spacers 6 disposed therebetween. That is, the conductive structure 3, the elastic electrode portion 4, and the spacers 6 are disposed between the substrate 2 and the electrode supporting component 5. The spacers 6 are formed of an insulating resin such as a polyester resin or an epoxy resin.

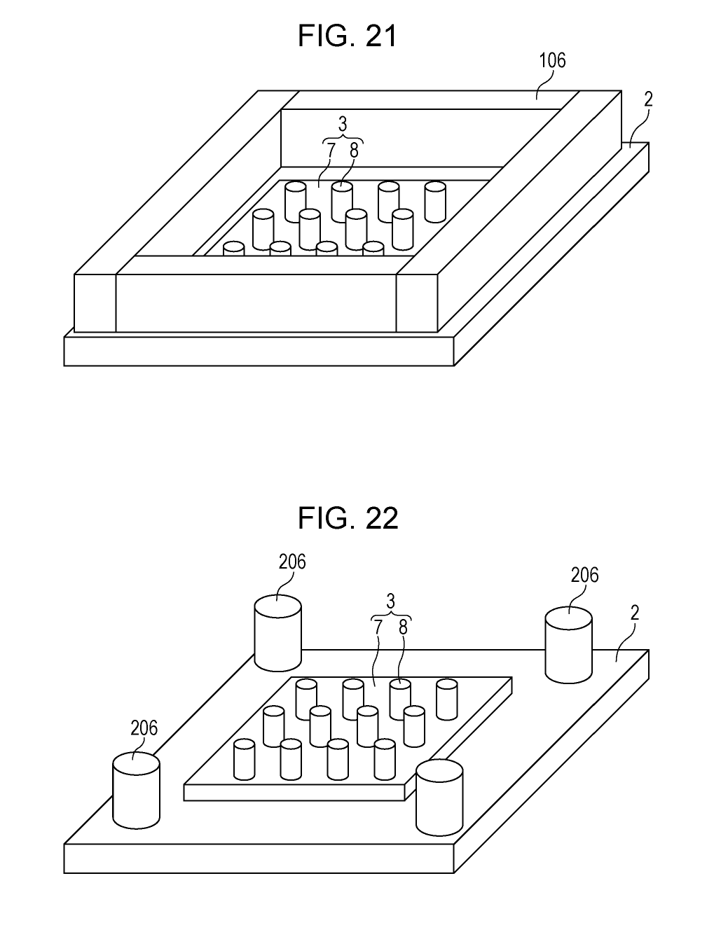

The spacer may be a frame-shaped spacer 106 that surrounds a plurality of the conductive components 8 as illustrated in FIG. 21. Alternatively, the spacer may be the columnar spacer 206. In this case, as illustrated in FIG. 22, a plurality of the columnar spacers 206 are disposed on the substrate 2 such that the substrate 2 is dotted with the spacers 206. When the substrate 2 is dotted with the plurality of spacers 206, the spacers 206 may have any of a columnar shape, a spherical shape, a semi-spherical shape, and a frusto-conical shape.

The substrate 2 may have flexibility. The “flexibility” of the substrate 2 here refers to properties, with which the substrate 2 is pliable and deformed without causing cracks when the substrate 2 is bent. When the substrate 2 has flexibility, the pressure-sensitive element 1 can be bonded to a curved surface through the substrate 2. That is, the pressure-sensitive element 1 can be disposed on devices (for example, a display and so forth) of various shapes. Although the material of the substrate 2 is not particularly limited, the substrate 2 is formed of, for example, a plastic such as polyethylene terephthalate, polycarbonate, or polyimide. The thickness of the substrate 2 is, for example, 25 to 500 μm when considering the durability and reduction of the thickness of the pressure-sensitive element 1.

As illustrated in FIGS. 1 and 2, the conductive structure 3 includes a conductive layer 7 and the conductive components 8. The conductive layer 7 is provided on the substrate 2. The conductive components 8 extend from the conductive layer 7 in a direction in which the substrate 2 and the electrode supporting component 5 oppose each other. It is sufficient that the conductive components 8 extend from the conductive layer 7 such that the conductive components 8 are substantially perpendicular to the conductive layer 7 and such that the tips of the conductive components 8 oppose the elastic electrode portion 4. The conductive components 8 extend from the conductive layer 7, for example, at an angle in a range from 60 to 90 degrees, that is in a range, for example, from 70 to 90 degrees relative to the conductive layer 7.

Also, as illustrated in FIGS. 1 and 2, in the first embodiment, the conductive components 8 of the conductive structure 3 are a plurality of columnar components that are spaced apart from one another on the conductive layer 7. In the first embodiment, the plurality of conductive components 8 have a uniform length from the conductive layer 7 to the tips thereof and are arranged on the conductive layer 7 in a regular manner. For example, the plurality of conductive components 8 are arranged in a matrix. Thus, the conductive components 8 have a regular structure.

Although the dimensions of the columns of the conductive components 8 are not particularly limited, the diameter and the height of the columns are, for example, respectively 10 to 500 μm and 10 to 500 μm. When the diameter is less than 10 mm, stress exerted on the elastic electrode portion 4 increases and resistance to degradation is reduced. When the diameter is more than 500 μm, pressure-sensitive characteristics may vary due to defects in the surface of the column or variation of the surface roughness of the surface of the column. When the height of the columns is less than 10 μm, the elastic electrode portion 4 may be brought into contact with the conductive layer 7 in the middle of pressing, and accordingly, the pressure-sensitive characteristics may not be obtained. When the height of the columns is more than 500 μm, the conductive components 8 may break when the conductive components 8 are repeatedly pressed.

When the columns of the conductive components 8 have the dimensions as described above, the columns of the conductive components 8 are spaced apart from one another by, for example, 10 to 200 μm, and about, for example, 1000 to 15000 columns per cm² are formed. When the number of columns of the conductive components 8 is less than 1000/cm², the contact area between the conductive components 8 and the elastic electrode portion 4 is insufficient, and accordingly, the resistance between the elastic electrode portion 4 and the conductive layer 7 is not sufficiently reduced even when the pressing force is increased. When the number of columns of the conductive components 8 is more than 15000, the contact area between the conductive components 8 and the elastic electrode portion 4 is large even when the pressing force is small. This causes steep reduction in the resistance between the elastic electrode portion 4 and the conductive layer 7. However, the above description does not limit the number of the conductive components 8. An optimum number of the conductive components 8 is determined in accordance with the contact resistance of the conductive components 8 with the elastic electrode portion 4 in addition to the dimensions of the conductive components 8.

In the first embodiment, the plurality of conductive components 8 of the conductive structure 3 each have, as illustrated in FIG. 3, a resin component 9, which extends from the conductive layer 7, and a plurality of conductive filler elements 10 uniformly contained in the resin component 9.

The resin components 9 are formed of a material such as, for example, a styrene based resin, a silicone based resin such as a polydimethyl polysiloxane (PDMS), an acrylic resin, or a rotaxane based resin. The conductive filler elements 10 are formed of a material selected from the group consisting of, for example, Au, Ag, Cu, C, ZnO, In₂O₃, SnO₂, and so forth.

The particle size of the plurality of conductive filler elements 10, which is sufficiently smaller than that of the protrusions and recesses of the surfaces of the conductive components 8, is equal to or less than, for example, about several hundred nm. The conductive filler elements 10 may have a shape such as a spherical shape, a plate shape, or a needle shape.

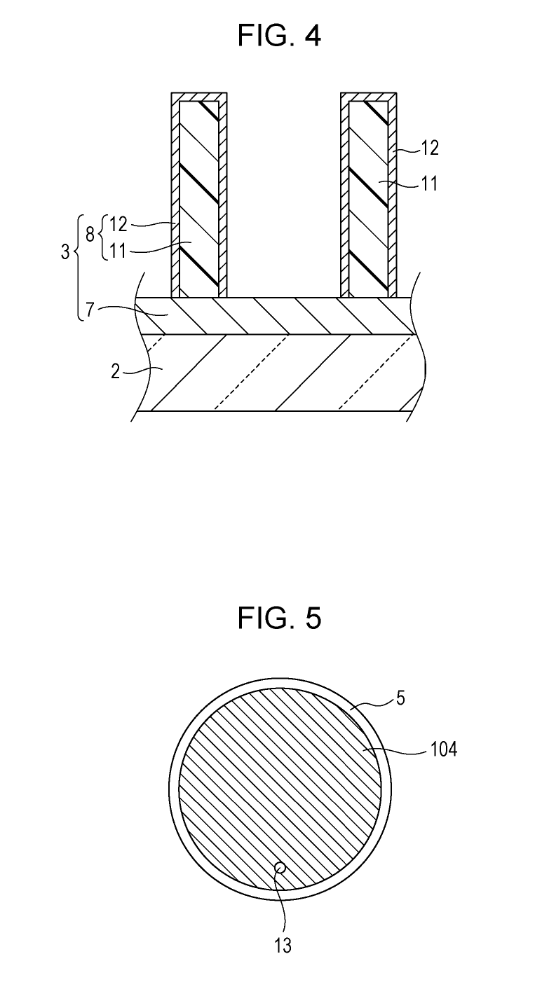

Alternatively, the plurality of conductive components 8 of the conductive structure 3 may include, as illustrated in FIG. 4, resin components 11, which extend from the conductive layer 7, and conductive layers 12 coated on the respective resin components 11. By coating the surfaces of the resin components 11 with the conductive layers 12 having a uniform thickness, the conductive components 8 are realized.

Although the details will be described later, the conductive components 8 of the conductive structure 3 have a higher elastic modulus than that of the elastic electrode portion 4. The elastic modulus of the conductive components 8 is higher than, for example, 108 Pa. The elastic modulus of the conductive components 8 can be adjusted by changing the material of the resin components 9 (11), the compounding ratio of the resin components 9 and the conductive filler elements 10, and so forth.

As illustrated in FIG. 1, in the first embodiment, a contact portion of the elastic electrode portion 4 is divided into a plurality of contact pieces, which oppose and are brought into contact with the tips of the conductive components 8 of the conductive structure 3. That is, a circular contact piece 4a is surrounded by an annular contact piece 4b. The contact pieces 4a and 4b have respective flat surfaces to be brought into contact with the conductive components 8 and respective electrical outlets 13.

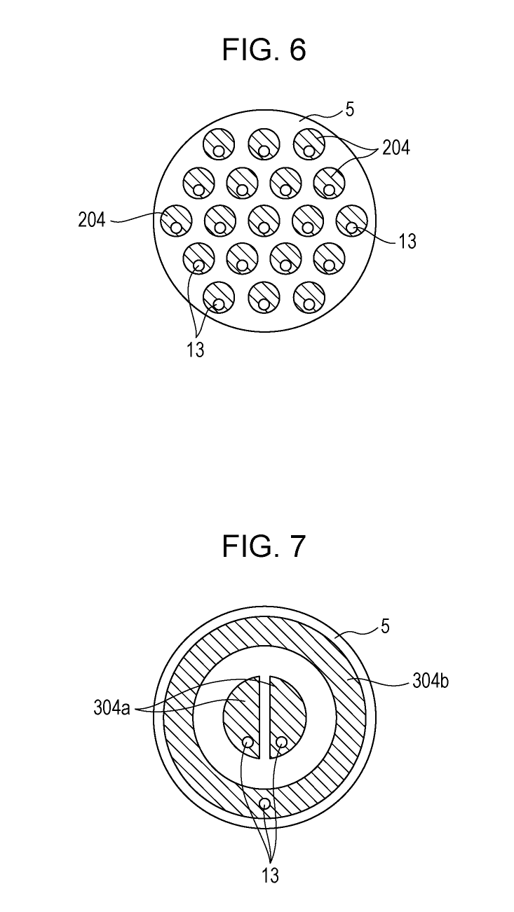

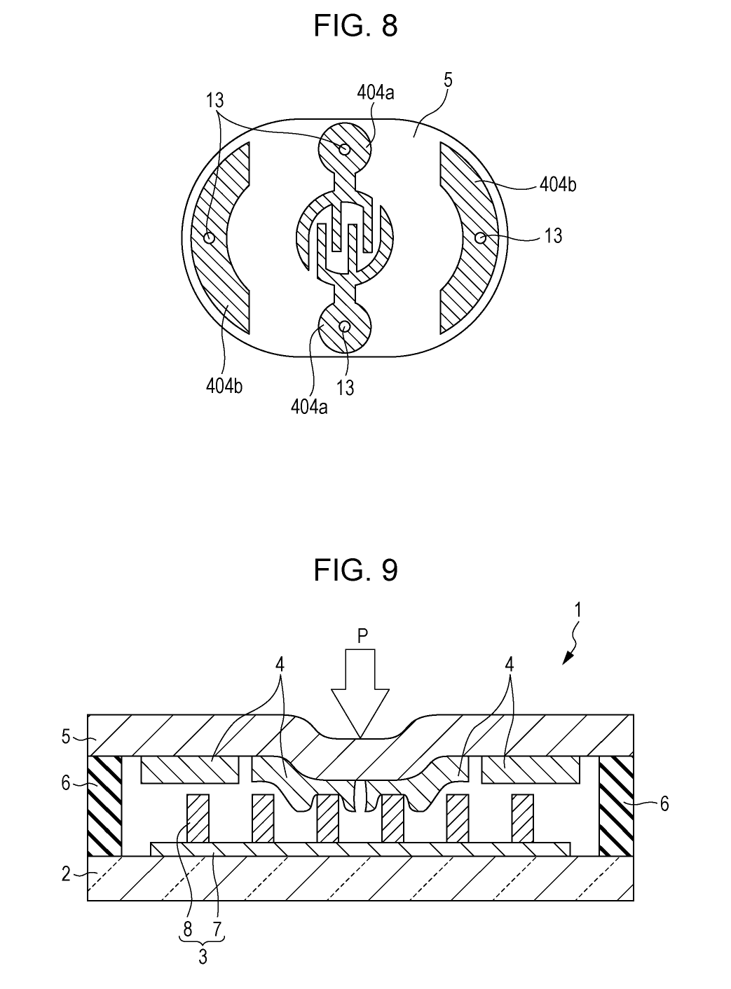

The elastic electrode portion 4 is not necessarily has the contact pieces that are patterned as illustrated in FIG. 1. The elastic electrode portion 4 may have a single circular contact piece 104 formed in the entirety of the electrode supporting component 5 as illustrated in FIG. 5. Alternatively, as illustrated in FIG. 6, the contact pieces of the elastic electrode portion 4 may be circular contact pieces 204 arranged in the electrode supporting component 5 in a regular manner. Alternatively, as illustrated in FIG. 7, the contact pieces of the elastic electrode portion 4 may be a pair of semi-circular central contact pieces 304a, which oppose each other, and an annular circumferential contact piece 304b, which surrounds the pair of circular contact pieces 304a. Alternatively, as illustrated in FIG. 8, the contact pieces of the elastic electrode portion 4 may be a pair of central contact pieces 404a having respective comb-like parts, the teeth of which are alternately arranged along the adjacent ends of the contact pieces 404a, and arc-shaped circumferential contact pieces 404b that oppose each other with the pair of comb-shaped contact pieces 404a interposed therebetween.

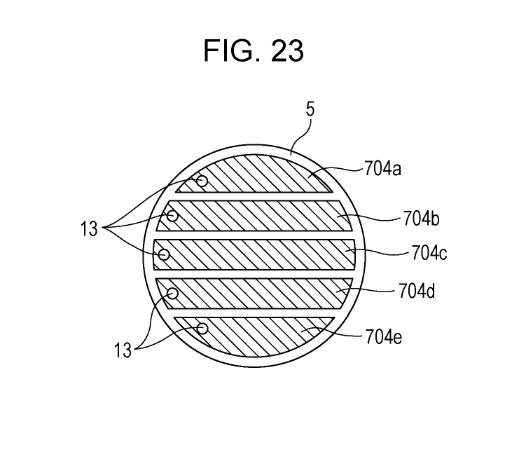

Alternatively, as illustrated in FIG. 23, the contact portion of the elastic electrode portion 4 may be divided into a plurality of contact pieces 704a to 704e, which are parallel to one another and spaced apart from one another. The gap between the adjacent contact pieces is about, for example, 1 to 10 mm although it varies depending on application.

As illustrated in FIG. 2, in a broad sense, the elastic electrode portion 4 does not have a protruding part or protruding parts that protrude toward the substrate 2 and are brought into contact with the conductive component 8, but a flat surface or flat surfaces that oppose and are to be brought into contact with the conductive components 8.

With the pressure-sensitive element 1 that includes the elastic electrode portion 4 having the contact pieces or the contact piece as illustrated in FIGS. 1 and 5 to 8, a change in the pressing force acting on the pressure-sensitive element 1 can be detected in accordance with a change in the resistance between the elastic electrode portion 4 and the conductive layer 7 of the conductive structure 3. That is, as illustrated in FIG. 9, as a pressing force P that presses the electrode supporting component 5 toward the substrate 2 is increased, the contact area between the conductive components 8 of the conductive structure 3 and the elastic electrode portion 4 is increased. Thus, the resistance between the elastic electrode portion 4 and the conductive layer 7 of the conductive structure 3 is increased.

With the pressure-sensitive element 1 that includes the elastic electrode portion 4, the contact portion of which have a plurality of contact patterns as illustrated in FIGS. 1 and 6 to 8, the change in the pressing force acting on the pressure-sensitive element 1 can be detected in accordance with the changes in the resistances between the plurality of contact pieces of the elastic electrode portion 4.

That is, as illustrated in FIG. 9, as the pressing force P that presses the electrode supporting component 5 toward the substrate 2 is increased, the contact area between the conductive components 8 of the conductive structure 3 and the elastic electrode portion 4 is increased. Thus, the resistances between the plurality of contact pieces of the elastic electrode portion 4, which are electrically connected to one another by the conductive structure 3, are reduced.

Furthermore, when the elastic electrode portion 4 has three or more contact pieces as illustrated in FIGS. 6 to 8, a position in the electrode supporting component 5, on which the pressing force acts, can be detected in accordance with changes in the resistances between various combinations of the contact pieces.

Furthermore, when the elastic electrode portion 4 includes a central and circumferential contact pieces as illustrated in FIGS. 1, 7, and 8, poor contact that locally occurs between the elastic electrode portion 4 and the conductive components 8 can be canceled off. As a result, a change in the resistance can be stably detected.

With the pair of central contact pieces 404a having respective comb-like parts, the teeth of which are alternately arranged along the adjacent ends of the contact pieces 404a, and the arc-shaped circumferential contact pieces 404b, which oppose each other with the pair of comb-shaped contact pieces 404a interposed therebetween as illustrated in FIG. 8, even when the position of the electrode supporting component 5 relative to the substrate 2 varies due to variation in the manufacture of the pressure-sensitive element 1, the pressure-sensitive element 1 can stably detect a change in the resistance.

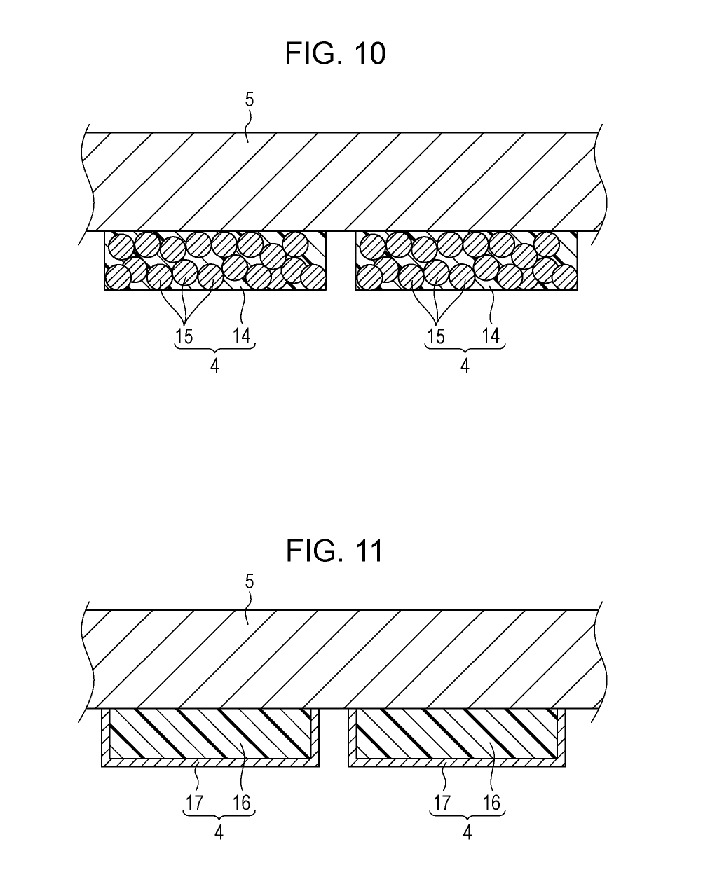

As illustrated in FIG. 10, the elastic electrode portion 4 includes a resin layer 14 provided at the electrode supporting component 5 and a plurality of conductive filler elements 15 uniformly contained in the resin layer 14.

The resin layer 14 is formed of, for example, a urethane resin, a styrene based resin, a silicone based resin such as polydimethyl polysiloxane (PDMS), an acrylic resin, or an elastic resin such as a rotaxane based resin. The conductive filler elements 15 are formed of a material selected from the group consisting of, for example, Au, Ag, Cu, C, ZnO, In₂O₃, SnO₂, and so forth.

Similarly to the particle size of the conductive filler elements 10, the particle size of the conductive filler elements 15 is sufficiently smaller than the patterned shape of the elastic electrode portion 4, and is about, for example, several hundred nm or smaller. The conductive filler elements 15 may have a shape such as a spherical shape, a plate shape or a needle shape.

When the electrode supporting component 5 is pressed, part of the elastic electrode portion 4, which corresponds to the pressed part of the electrode supporting component 5, is uniformly deformed in accordance with the elastic property of the elastic electrode portion 4. At this time, a total contact area between the conductive filler elements 15 contained in the deformed elastic electrode portion 4 also changes. Accordingly, the conductivity of the elastic electrode port:on 4 changes. As a result, although the details will be described later, the resistance between the elastic electrode portion 4 and the conductive layer 7 of the conductive structure 3 (or resistances between the plurality of the contact pieces of the elastic electrode portion 4) is significantly changed corresponding to a change in the pressing force acting on the electrode supporting component 5.

Alternatively, as illustrated in FIG. 11, the elastic electrode portion 4 may include a resin layer 16 provided at the electrode supporting component 5 and a conductive layer 17 coated on the resin layer 16. The conductive layer 17 is formed so that the resin layer 16 is coated with the conductive layer 17 of a uniform thickness.

When the elastic electrode portion 4 is brought into contact with the conductive components 8 of the conductive structure 3 by pressing the electrode supporting component 5, the resin layer 16 and the conductive layer 17 are compressed, and the thickness of the conductive layer 17 is reduced. Accordingly, the resistance of the elastic electrode portion 4 is increased. This increases the smoothness, with which the resistance between the elastic electrode portion 4 and the conductive layer 7 of the conductive structure 3 (or the resistances between the plurality of the contact pieces of the elastic electrode portion 4) is changed corresponding to a change in the pressing force acting on the electrode supporting component 5.

The elastic modulus of the elastic electrode portion 4 as described above, lower than that of the conductive components 8 of the conductive structure 3. For example, the elastic modulus of the elastic electrode portion 4 is about 104 to 108 Pa so that the elastic electrode portion 4 is gradually deformed at about 1 to 10 N, which is the pressing force when the pressure-sensitive element 1 is used as a pressure-sensitive switch.

As described above, the elastic modulus of the conductive components 8 of the conductive structure 3 is higher than that of the elastic electrode portion 4. That is, as illustrated in FIG. 9, the conductive components 8 and the elastic electrode portion 4 are formed so that, when the elastic electrode portion 4 and the conductive components 8 are brought into contact with one another by the pressing force P acting on the electrode supporting component 5, the elastic electrode portion 4 is deformed while the conductive components 8 are not deformed.

When the conductive components 8 and the elastic electrode portion 4 have the resin and the plurality of conductive filler elements contained in the resin as illustrated in FIGS. 3 and 10, the elastic moduli of the conductive components 8 and the elastic electrode portion 4 are adjusted by changing, for example, mechanical characteristics of the resin components 9 and the resin layer 14, mechanical characteristics and the shapes of the conductive filler elements 10 and 15, and the ratio of the resin components 9 to the conductive filler elements 10 and the ratio of the resin layer 14 to the conductive filler elements 15.

When the conductive components 8 and the elastic electrode portion 4 have the resin and the conductive layers coated on the resin as illustrated in FIGS. 4 and 11, the elastic moduli of the conductive components 8 and the elastic electrode portion 4 are adjusted b changing mechanical characteristics of the resin components 11 and the resin layer 16.

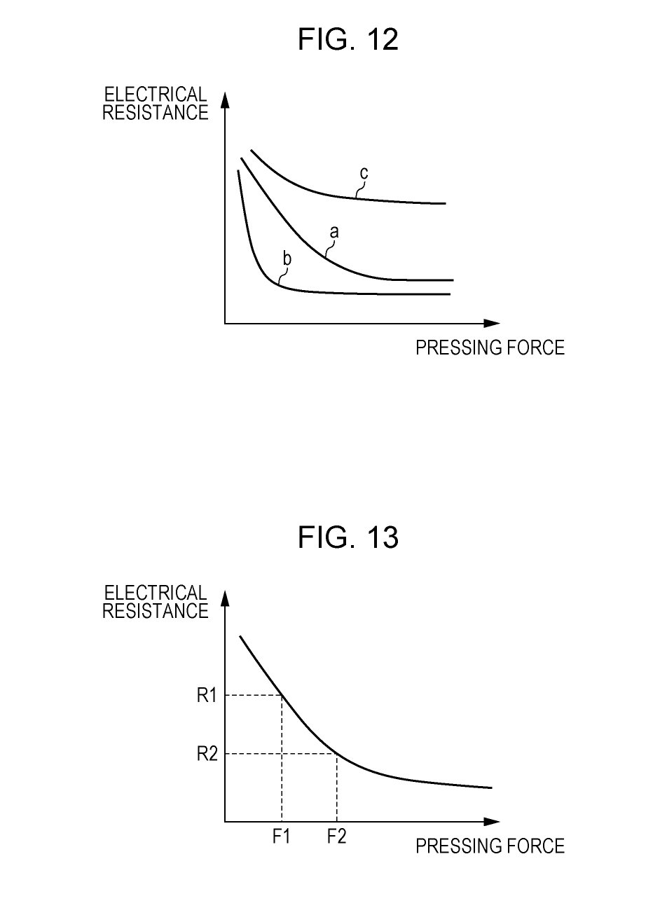

FIG. 12 illustrates electrical resistance characteristics of pressure-sensitive elements a to c, which include the respective elastic electrode portions 4 having different elastic characteristics.

Specifically, FIG. 12 illustrates changes in the electrical resistance between the elastic electrode portion 4 and the conductive layer 7 of the conductive structure 3 corresponding to a change in the pressing force acting on the electrode supporting component 5 of the pressure-sensitive elements a to c. The pressure-sensitive element a has the elastic electrode portion 4 having an elastic modulus of 104 to 100 Pa. The pressure-sensitive element b has the elastic electrode portion 4 having a lower elastic modulus than 104 Pa. The pressure-sensitive element c has the elastic electrode portion 4 having a higher elastic modulus than 108 Pa.

Referring to FIG. 12, with the pressure-sensitive element b, even when the pressing force acting on the electrode supporting component 5 is relatively small, the elastic electrode portion 4 easily changes and the contact area between the conductive components 8 and the elastic electrode portion 4 is steeply increased. That is, the resistance is significantly reduced by a small pressing force. Thus, with the pressure-sensitive element b, it is unlikely that a change in the pressing force is highly accurately detected in accordance with a change in the resistance.

Referring to FIG. 12, with the pressure-sensitive element c, even when the pressing force acting on the electrode supporting component 5 is relatively increased, the elastic electrode portion 4 is not easily deformed. Accordingly, the contact area between the conductive components 8 and the elastic electrode portion 4 is changed little. Thus, even when the pressing force is changed, the resistance between the elastic electrode portion 4 and the conductive layer 7 of the conductive structure 3 is changed little. Thus, with the pressure-sensitive element c, it is unlikely that a change in the pressing force is accurately detected in accordance with a change in the resistance.

In comparison with the pressure-sensitive elements b and c, with the pressure-sensitive element a, the contact area between the conductive components 8 and the elastic electrode portion 4 is gradually increased as the pressing force is changed when the pressing force is, for example, about 1 to 10 N as described above. Accordingly, as illustrated in FIG. 12, the resistance is gently reduced. Thus, with the pressure-sensitive element a, a change in the pressing force can be accurately detected in a wide range of stress in accordance with a change in the resistance.

The contact resistance between the elastic electrode portion 4 and the conductive components 8 for example, 10⁻⁵ Ω/cm² to 10⁻³ Ω/cm², the surface resistivities of the elastic electrode portion 4 and the conductive layer 7 of the conductive structure 3 are, for example, equal to or less than 10 kΩ/sq. and the resistivity of the conductive components 8 is, for example, equal to or less than 10⁵ Ω·cm.

The pressure-sensitive element 1 of the first embodiment is substantially configured so that the pressing force can be detected accordance with the contact resistance between the elastic electrode portion 4 and the conductive components 8.

In the case where the contact resistance between the elastic electrode portion 4 and the conductive components 8 is relatively excessively low, the resistance between the elastic electrode portion 4 and the conductive layer 7 of the conductive structure 3 is low even when the contact area between the elastic electrode portion 4 and the conductive components 8 is reduced by reducing the pressing force acting on the electrode supporting component 5. Thus, it is unlikely that a change in the resistance corresponding to a change in the pressing force is accurately detected.

In contrast, in the case where the contact resistance between the elastic electrode portion 4 and the conductive components 8 is relatively excessively high, the resistance between the elastic electrode portion 4 and the conductive layer 7 of the conductive structure 3 is high even when the contact area between the elastic electrode portion 4 and the conductive components 8 is increased by increasing the pressing force acting on the electrode supporting component 5. Thus, it is unlikely that a change in the resistance corresponding to a change in the pressing force is accurately detected.

Furthermore, in the case where the surface resistivities of the elastic electrode portion 4 and the conductive layer 7 of the conductive structure 3 are higher than 10 kΩ/sq., or in the case where the resistivity of the conductive components 8 is higher than 10⁵ Ω·cm, the resistances of the elastic electrode portion 4, the conductive layer 7, and the conductive components 8 are high in relation to the change in the contact resistance between the elastic electrode portion 4 and the conductive components 8. Thus, pressure-sensitive characteristics cannot be obtained.

When the elastic electrode portion 4, the conductive layer 7 of the conductive structure 3, and the conductive components 8 are formed of ink that contains resin mixed with conductive particles, the resistances of the elastic electrode portion 4, the conductive layer 7 of the conductive structure 3, and the conductive components 8 can be set to desired values by adjusting, for example, the concentration and shape of the conductive particles in the ink. In this case, the materials are selected so that the elastic characteristics of the elastic electrode portion 4 and the conductive components 8 are also obtained. Furthermore, when the conductive layers on the surfaces of the elastic electrode portion 4 and the conductive components 8 are formed by plating, the desired resistances can be obtained by desirably changing, for example, the densities of the plated films by adjusting the compositions, concentrations, temperatures, and so forth of plating solutions.

As illustrated in FIG. 9, when the electrode supporting component 5 is pressed toward the substrate 2, the pressed part of the electrode supporting component 5 and corresponding parts of the elastic electrode portion 4 are bent so as to have protruding shapes that protrude in the pressing direction. This occurs since the electrode supporting component 5 and the elastic electrode portion 4 have flexibility.

When the electrode supporting component 5 is bent, the elastic electrode portion 4 is brought into contact with the tips of the conductive components 8 of the conductive structure 3. Thus, the elastic electrode portion 4 and the conductive layer 7 of the conductive structure 3 are electrically connected to each other.

When the electrode supporting component 5 continues to be bent to the substrate 2 side (the pressing force P continues to be increased), the elastic electrode portion 4 in contact with the conductive components 8 continues to be deformed in a uniform manner, and the contact area between the elastic electrode portion 4 and the conductive components 8 continues to be changed in a uniform manner. Thus, the resistance between the elastic electrode portion 4 and the conductive layer 7 of the conductive structure 3 is continuously reduced.

The deformation of the elastic electrode portion 4 in the uniform manner referred to herein means as follows: that is, assuming that there are a plurality of the pressure-sensitive elements 1, the elastic electrode portions 4 having been brought into contact with the conductive components 8 of the conductive structures 3 are deformed into a uniform shape when the electrode supporting components 5 of the plurality of pressure-sensitive elements 1 are pressed under the same pressing conditions. This deformation of the elastic electrode portions 4 in the uniform manner is realized when, as described above, the conductive components 8 have a regular structure, are not deformed even when brought into contact with the elastic electrode portion 4, and are brought into contact with flat surface portions of the elastic electrode portion. 4.

FIG. 13 illustrates a change in the electrical resistance between the elastic electrode portion 4 and the conductive layer 7 of the conductive structure 3 corresponding to a change in the pressing force acting on the electrode supporting component 5. As illustrated in FIG. 13, as the pressing force acting on the electrode supporting component 5 is continuously increased, the resistance between the elastic electrode portion 4 and the conductive layer 7 of the conductive structure 3 is continuously reduced. This continuous reduction of the resistance is realized by the increase in the uniform manner in the contact area between the elastic electrode portion 4 and the conductive components 8 having a regular structure occurring as the pressing force is increased. Thus, the pressing force acting on the electrode supporting component 5 can be accurately detected in accordance with a change in the resistance.

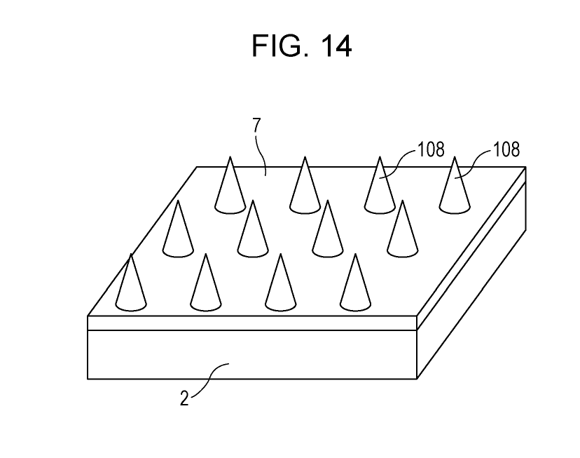

Although the conductive components 8 of the first embodiment have a columnar shape, the shape of the conductive components 8 is not limited to this. The conductive components may be, for example, conical conductive components 108 as illustrated in FIG. 14. Alternatively, the conductive components may have a frusto-conical shape or semi-spherical shape.

In particular, when the conductive components 8 shape having a tapered surface such as a conical, frusto-conical, or semi-spherical shape, the contact area between the elastic electrode portion 4 and the conductive components 8 is continuously increased as the pressing force acting on the electrode supporting component 5 is increased. That is, when focusing on one of the conductive components 8, as the pressing force acting on the electrode supporting component 5 is increased, the elastic electrode portion 4 approaches the substrate 2. As the elastic electrode portion 4 approaches the substrate 2, the contact area between the elastic electrode portion 4 and the tapered surface of the one conductive component 8 is continuously increased.

Furthermore, the surfaces of the conductive components 8, in particular, the surfaces of the conductive components 8 that can be brought into contact with the elastic electrode portion 4 have, for example, fine protrusions and recesses arranged in a regular manner. By adjusting, for example, the difference in the height of the fine protrusions and recesses arranged in the regular manner, the contact area between the conductive components 8 and the elastic electrode portion 4 can be changed in a further continuous manner corresponding to a change in the pressing force acting on the electrode supporting component 5. As a result, a change in the pressing force acting on the electrode supporting component 5 can be accurately detected.

According to the first embodiment having been described, variation of change in the resistances corresponding to a change in the pressing force in the plurality of pressure sensitive elements 1 is reduced, and the durability of the pressure-sensitive elements 1 can be improved.

That is, in the plurality of pressure-sensitive elements 1, since the elastic electrode portions 4 are deformed in the uniform manner as described above, the contact areas between the elastic electrode portions 4 and the conductive components 8 are increased in the uniform manner as the pressing forces are increased As a result, in each of the pressure-sensitive elements 1, variation of change in the resistance corresponding to a change in the pressing force can be reduced under the same pressing conditions. Furthermore, since the conductive components can be designed in advance, variation among individual units of the plurality of pressure-sensitive elements can also be reduced.

Furthermore, since the conductive components 8 having a protruding shape are brought into contact with the flat surfaces of the elastic electrode portion 4, cracks are unlikely to be caused (compared to the case where a hard electrode is brought into contact with the conductive components 8 having the protruding shape). Thus, the pressure-sensitive element 1 has a high durability.

### Second Embodiment

Although a pressure-sensitive element according to a second embodiment is substantially the same as the pressure-sensitive element according to the above-described first embodiment, the conductive components of the conductive structure are different from those of the first embodiment. Thus, the details of the conductive components of the pressure sensitive element according to the second embodiment are described.

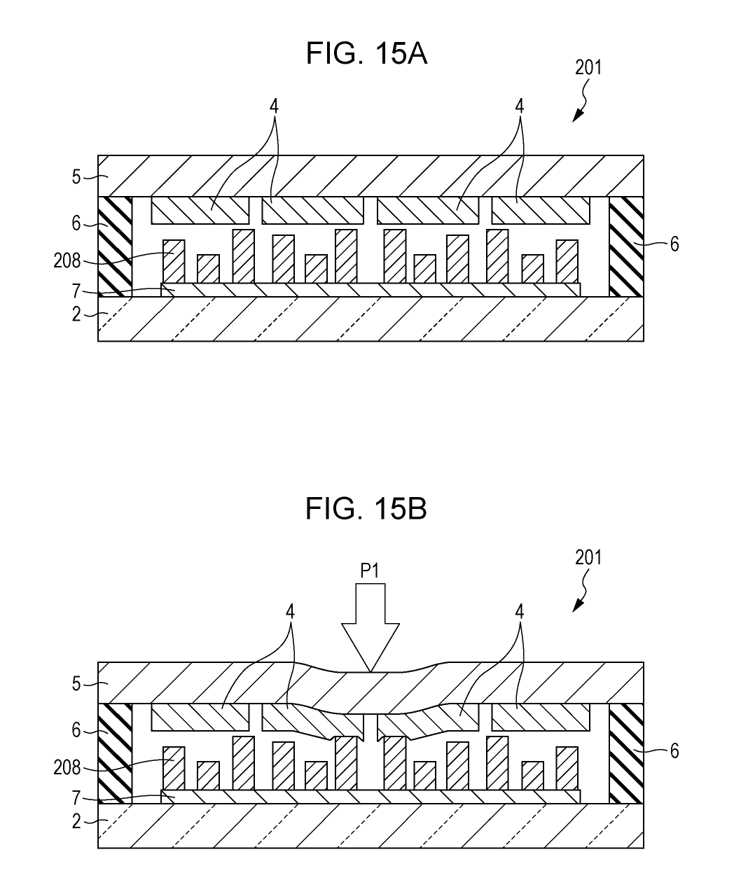

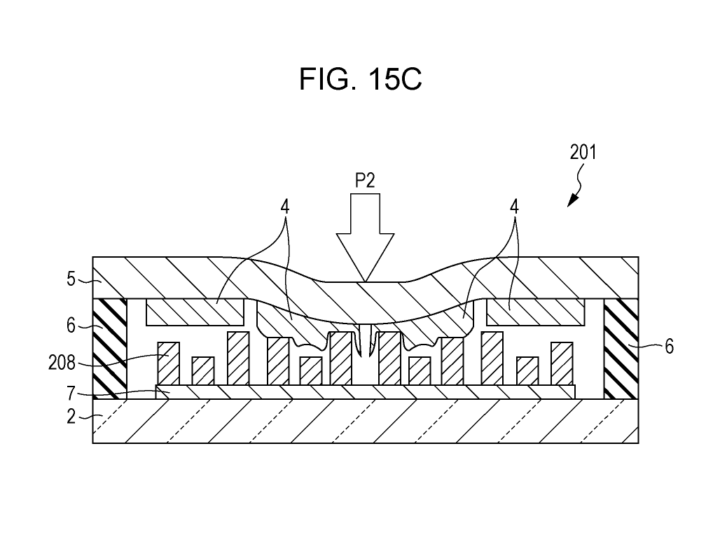

FIGS. 15A to 15C are schematic sectional views of a pressure-sensitive element 201 according to the second embodiment. FIG. 15A illustrates the pressure-sensitive element 201 to which the pressing force is not applied. FIG. 15B illustrates the pressure-sensitive element 201 to which a relatively small pressing force P1 is applied. FIG. 15C illustrates the pressure-sensitive element 201 to which a relatively large pressing force P2 is applied.

As illustrated in FIGS. 15A to 15C, the length of at least two of a plurality of conductive components 208 of the pressure-sensitive element 201 from the substrate 2 (conductive layer 7) to the tips of the conductive components 208 is different from that of the other conductive components 208.

In the case where the plurality of conductive components 208 have a uniform length from the substrate 2 (conductive layer 7) to the tips of the conductive components 208, the elastic electrode portion 4 may be simultaneously brought into contact with the plurality of conductive components 208 when the electrode supporting component 5 is pressed. This significantly increases the contact area between the elastic electrode portion 4 and the conductive components 208, thereby significantly reducing the resistance between the elastic electrode portion 4 and the conductive components 208.

In the case where at least two of the plurality of conductive components 208 have the length, which is different from that of the other conductive components 208, the relatively long conductive components 208 are initially brought into contact with the elastic electrode portion 4 as illustrated in FIG. 15B when the electrode supporting component 5 is pressed by the relatively small pressing force P1.

Next, when the pressing force is increased from the pressing force P1 to the pressing force P2, the relatively short conductive components 208 are brought into contact with the elastic electrode portion 4 as illustrated in FIG. 15C.

As described above, when the plurality of conductive components 208 have different lengths, the number of the conductive components 208 in contact with the elastic electrode portion 4 is increased as the pressing force acting on the electrode supporting component 5 is increased. Thus, by appropriately setting the lengths of the conductive components 208, the contact area between the elastic electrode portion 4 and the conductive components 208 can be gently changed as the pressing force is changed. That is, the resistance between the elastic electrode portion 4 and the conductive layer 7 can be gently changed as the pressing force is changed.

According to the second embodiment, the accuracy at which the pressing force acting on the electrode supporting component 5 is detected can be increased.

### Third Embodiment

A pressure-sensitive element according to a third embodiment is substantially the same as the pressure-sensitive element according to the second embodiment. However, the conductive components of the third embodiment are different from those of the second embodiment. Thus, the details of the conductive components of the pressure-sensitive element according to the third embodiment are described.

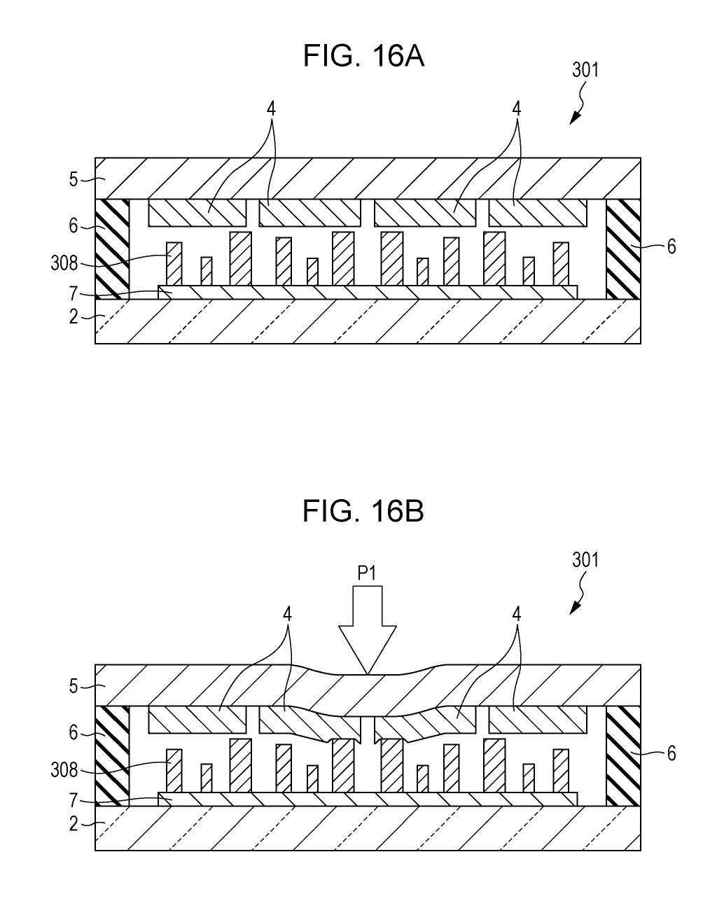

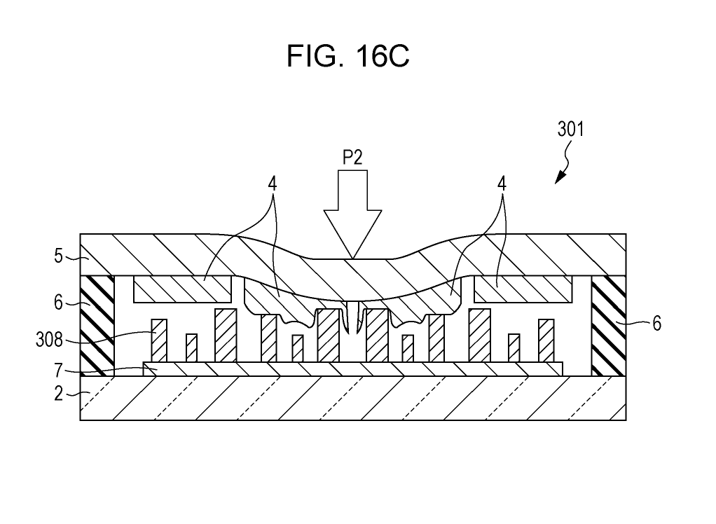

FIGS. 16A to 16C are schematic sectional views of a pressure-sensitive element 301 according to the third embodiment. FIG. 16A illustrates the pressure-sensitive element 301 to which the pressing force is not applied. FIG. 16B illustrates the pressure-sensitive element 301 to which the relatively small pressing force P1 is applied. FIG. 16C illustrates the pressure-sensitive element 301 to which the relatively large pressing force P2 is applied.

As illustrated in FIGS. 16A to 16C, as is the case with the above-described second embodiment, the length of at least two of a plurality of conductive components 308 of the pressure-sensitive element 301 from the substrate 2 (conductive layer 7) to the tips of the conductive components 308 is different from that of the other conductive components 308. In a projection in a direction in which the substrate 2 and the electrode supporting component 5 oppose each other, a projected sectional area of the relatively long conductive components 308 is larger than that of the relatively short conductive components 308.

In the structure as described above, the relatively short conductive components 308 are brought into contact with the elastic; electrode portion 4 as illustrated in FIG. 16C after the relatively long conductive components 308 have been brought into contact with the elastic electrode portion 4 as illustrated in FIG. 16B. At this time, the projected sectional area of the conductive components 308, which are brought into contact with the elastic electrode portion 4 later, is smaller than that of the conductive components 308, which are initially brought into contact with the elastic electrode portion 4. Thus, the contact area between the elastic electrode portion 4 and the conductive components 308 is gently increased (compared to the case where the projected sectional area or the conductive components 308 initially brought into contact with the elastic electrode portion 4 is the same as that of the conductive components 308 brought into contact with the elastic electrode portion 4 later). Thus, by appropriately setting the size of the projected sectional area of the conductive components 308, the contact area between the elastic electrode portion 4 and the conductive components 308 can be gently changed as the pressing force is changed. That is, the resistance between the elastic electrode portion 4 and the conductive layer 7 can be gently changed as the pressing force is changed.

When the conductive components 8 are formed by photolithoetching, the projected sectional area of the conductive components can be designed in advance and the height can be changed by changing etching conditions.

According to the third embodiment, the accuracy at which the pressing force acting on the electrode supporting component 5 is detected can be further increased.

### Fourth Embodiment

The pressure-sensitive element according to the first to third embodiments described above has a plurality of conductive components. In contrast, a pressure-sensitive element according to a fourth embodiment has a single conductive component. Other structural elements of the fourth embodiment are the same as those of the above-described embodiments. Thus, the conductive component according to the fourth embodiment is described.

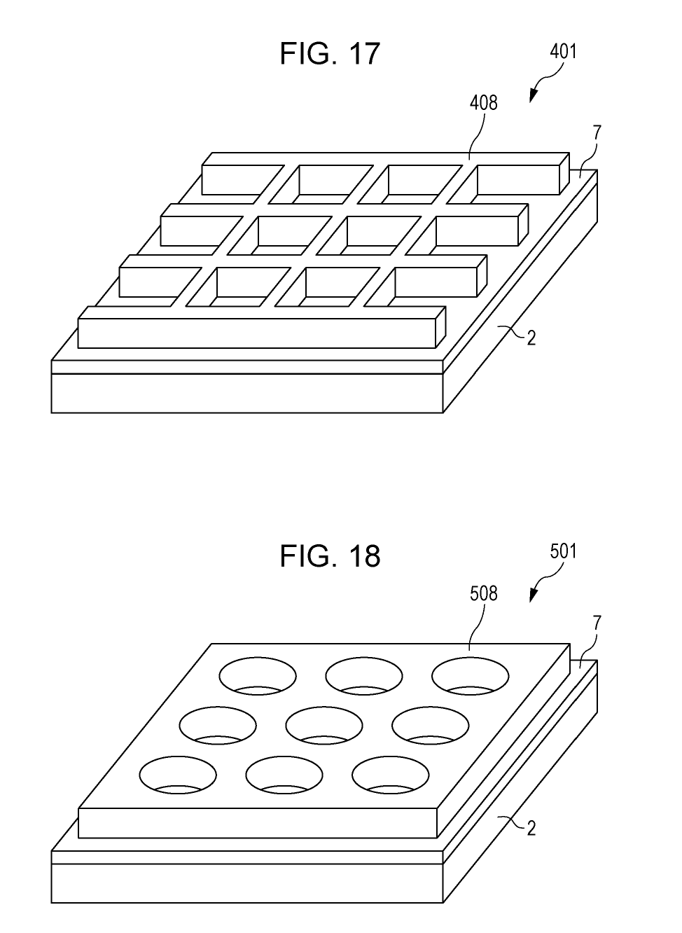

FIG. 17 illustrates a conductive component 408 of a pressure-sensitive element 401 according to the fourth embodiment.

The conductive component 408 is a single component that extends from the conductive layer 7 on the substrate 2 toward the elastic electrode portion 4 and has a size extending over substantially the entirety of the substrate 2. The conductive component 408 has a grid shape when seen in an opposing direction, in which the substrate 2 and electrode supporting component oppose each other. That is, the conductive component 408 has a plurality of through holes that penetrate therethrough in the opposing direction, in which the substrate 2 and the electrode supporting component 5 oppose each other, and the section perpendicular to the opposing direction is uniformly shaped.

Instead of the grid-shaped conductive component 408, the conductive component may be a conductive component 508 having a block shape, through which a plurality of through holes penetrate, as illustrated in FIG. 18.

With the conductive component 408, 508 according to the fourth embodiment, the elastic electrode portion 4 can be brought into contact with inner circumferential surfaces of the plurality of through holes in addition to the surface of the conductive component 408, 508 opposing the elastic electrode portion 4. Thus, as the pressing force acting on the electrode supporting component 5 is increased, a contact area between the elastic electrode portion 4 and the conductive component 408, 508 is increased.

In the case where the elastic electrode portion 4 is in contact with the conductive component 408, 508 through the plurality of contact pieces as illustrated in FIGS. 1, 6, 7, and 8, and the pressing force acting on the electrode supporting component 5 is detected in accordance with the resistances between the plurality of contact pieces, the conductive layer 7 disposed between the conductive component 408, 508 and the substrate 2 may be omitted.

When the conductive component is a single component, the sectional area of which is uniform as is the case with the conductive component 408, 508, the durability of the pressure sensitive element is improved compared to the pressure-sensitive element that has a plurality of conductive components having a shape such as the columnar shape as in the first embodiment.

According to the fourth embodiment, the pressing force acting on the electrode supporting component 5 can be accurately detected. Furthermore, the pressure-sensitive element 401, 501 having a high durability can be obtained.

### Fifth Embodiment

A pressure-sensitive element according to the embodiments of the present disclosure (including the above-described embodiments) may allow light in the visible range to be transmitted therethrough from the substrate 2 side to the electrode supporting component 5 side or a direction opposite to this direction.

That is, the structural elements of the pressure-sensitive element 1 (201, 301, 401, 501), the elements including the substrate 2, the conductive layer 7, the conductive component 8 (108, 208, 308, 408, 508), the elastic electrode portion 4, and the electrode supporting component 5, are transparent in the visible light range.

The transparent, substrate 2 is formed of a material such as, for example, polyethylene terephthalate or polycarbonate.

The resin component 9, 11 of the transparent conductive component 8 (108, 208, 308, 408, 508) and the resin layer 14, 16 of the elastic electrode portion 4 are each formed of a material having a high transparency such as, for example, a silicone based resin, a styrene based resin, an acrylic resin such as polymethacrylic acid methyl, or a rotaxane based resin. The transparent conductive filler elements 10, 15, which are formed of a material such as, for example, In₂O₃, ZnO, SnO₂, Au, Ag, Cu, or C, are contained in the transparent resin component 9 and the resin layer 14. In order to obtain a high transmittance, the shape and the size of the conductive filler elements 10, 15 are a spherical shape of several ten nm or a wire shape having a diameter of several ten nm.

Alternatively, the surfaces of the transparent resin component 11 and the transparent resin layer 16 may be coated with ink containing the above-described transparent conductive filler elements 10, 15 as the transparent conductive layer 12, 17.

The transparent conductive layer 7 of the conductive structure 3 is formed by performing sputtering on a transparent semiconductor material such as In₂O₃, ZnO, or SnO₂, or applying nano particles. Alternatively, wire-shaped particles of, for example, Au, Ag, Cu, or C having a diameter of several ten nm may be applied to the substrate 2 to form the conductive layer 7. Alternatively, the conductive layer 7 may be formed of a mesh pattern of about several to several ten μm formed by lines having a width of about several hundred nm to several hundred μm made of, for example, Ag or Cu.

According to the fifth embodiment, the pressure-sensitive element, which is transparent in the visible light range, can be obtained. The transparent pressure-sensitive element can be mounted on an image display surface such as, for example, a touch panel display.

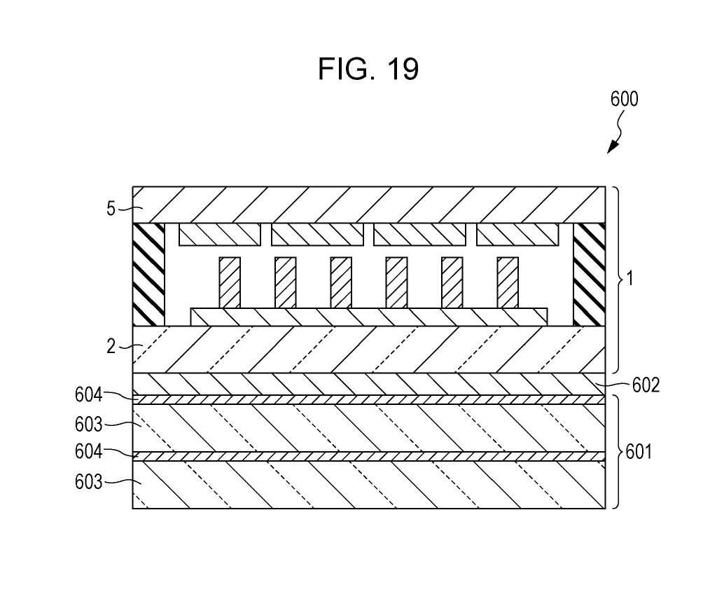

For example, FIG. 19 is a schematic sectional view of a touch panel 600 that includes the pressure-sensitive element according to the embodiments of the present disclosure (pressure-sensitive element 1 according to first embodiment as an example). As illustrated in FIG. 19, the touch panel 600 includes a sensor 601 and a cover film 602. The sensor 601 is stacked on the pressure-sensitive element 1 on the substrate 2 side and detects a pressed position of the electrode supporting component 5 of the pressure-sensitive element 1 when the electrode supporting component 5 is pressed. The cover film 602 is disposed between the pressure-sensitive element 1 and the sensor 601. In the touch panel 600 as described above, when a position on the surface of the electrode supporting component 5 is touched by, for example, a human finger, the touched position and the magnitude of a touching force (pressing force) can be detected. The sensor 601 may be stacked on the pressure-sensitive element 1 on the electrode supporting component 5 side. In this case, the pressure-sensitive element 1 is pressed through the sensor 601.

The sensor 601 may use a sensor that detects a pressed position on a flat surface by an electrostatic capacitive method.

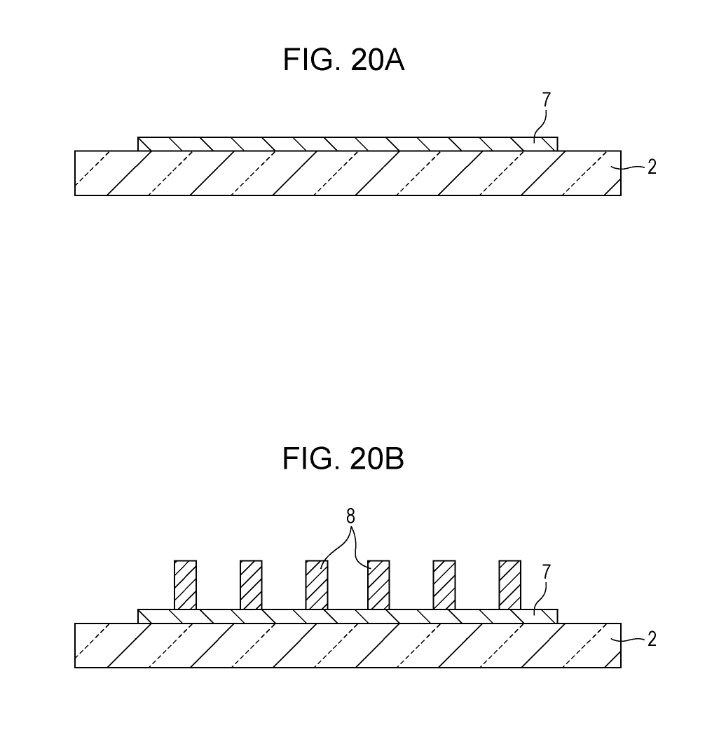

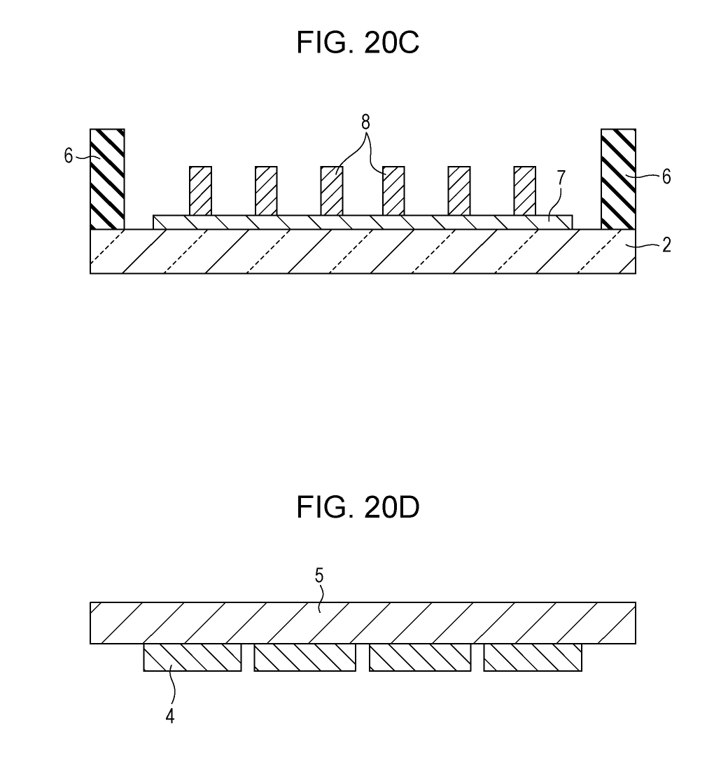

Hereafter, a method of producing the pressure-sensitive element according to the embodiments of the present disclosure is described. The method of producing the pressure-sensitive element 1 according to the first embodiment is described here with reference to FIGS. 20A to 20D.

Initially, as illustrated in FIG. 20A, the conductive layer 7 is formed on the substrate 2. The substrate 2, which has flexibility, is formed of a plastic such as, for example, polyethylene terephthalate, polycarbonate, or polyimide. Although a method of fabricating the conductive layer 7 is not particularly limited, the conductive layer 7 can be easily formed by, for example, applying ink that contains conductive particles to the substrate 2 continuously without gaps. The conductive particles contained in the ink are selected from the group consisting of, for example, Au, Ag, Cu, C, ZnO, In₂O₃, SnO₂, and so forth. The conductive particles are dispersed in the ink. When an ink, in which the conductive particles are dispersed, is used, a paste made by mixing a binder resin, an organic solvent, and the conductive particles can be printed on the substrate 2 Thus, the binder resin functions as a binder that causes the conductive particles to be bound to one another. This can improve the durability of the conductive layer 7.

Furthermore, by appropriately adjusting the viscosity of the ink to be applied, the conductive layer 7 having a uniform thickness can be formed on the substrate 2. Examples of the binder resin include, for example, ethylcellulose based resin, acrylic resin, and so forth. Examples of the organic solvent include, for example, terpineol, butyl carbitol acetate, and so forth.

Alternatively, the conductive layer 7 can be formed by non-electrolytic plating. Non-electrolytic plating is a technique, by which a metal thin film, that is, the conductive layer 7, is formed on a target surface in a plating solution by electrons supplied by oxidation reaction of a reducing agent added to the plating solution. Unlike electroplating, no current flows through the plating solution during non-electrolytic plating. Thus, not only conductive materials bun also non-conductive materials such as plastic that form the substrate 2 can be plated. When plating non-conductive materials such as plastic, a catalyst that facilitates the oxidation reaction of the reducing agent is added to the plating solution. Although the catalyst is not particularly limited, for example, a Pd or the like is used.

By dipping the substrate 2 into the plating solution containing a desired metal element, a layer of the desired metal element, that is, the conductive layer 7 is formed on the substrate 2. The conductive layer 7 having a desired resistance can be formed by adjusting the composition ratio, the concentration, the temperature, and so forth of the plating solution.

The method of forming the conductive layer 7 is not limited to the above-described method, in which the ink containing the conductive particles dispersed in the ink is used, or the above-described method using the non-electrolytic plating. Other than these methods, the conductive layer 7 can be formed by, for example, a sol-gel method. The sol-gel method refers to a solution phase synthesis, in which a polymer solid is obtained by utilizing hydrolysis and polycondensation reaction of a metal alkoxide compound or a metal salt. Alternatively, the conductive layer 7 can be formed by, for example, a method such as sputtering or vapor deposition.

A composite material is applied on the conductive layer 7 formed on the substrate 2 as illustrated in FIG. 20A. The composite material is formed by mixing a liquid polymer resin material such as a urethane based resin, a silicone based resin, a styrene based resin, an acrylic resin, or a rotaxane based resin with the conductive filler elements. The conductive filler elements are formed of a material selected from the group consisting of Au, Ag, Cu, C, ZnO, In₂O₃, SnO₂, and so forth. In order to control the elastic modulus, the tincture, and the refractive index of the conductive components 8, insulating filler may be mixed. Next, the composite material applied to the conductive layer 7 is formed by using a mold having a pattern of protrusions and recesses, and the formed composite material in the mold is cured. Thus, as illustrated in FIG. 20B, the plurality of conductive components 8, which are columns corresponding to the protrusion and recess pattern of the mold and contain the conductive filler elements, are formed.

The conductive components having, for example, a conical, frusto-conical, semi-spherical, or grid shape can be formed by changing the protrusion and recess pattern of the mold.

In the case where the conductive components 8 are formed by forming the conductive layers 12 on the surfaces of the resin components 11 as illustrated in FIG. 4, the columnar resin components 11 are formed by the protrusion and recess pattern of the mold, and the ink containing the conductive filler elements is applied to the surface of the resin components 11 having been formed so that the applied ink has a uniform thickness.

This method of forming the conductive components 8 uses a nano imprint, technique. The nano imprint technique refers to a technique, in which a mold having a protrusion and recess pattern is pressed against resin as a target material of transfer so as to transfer the protrusion and recess pattern formed in the mold in the order of nm to the resin. Compared to the existing lithographic technique, fine patterns can be formed, and spatial structures having a slope such as a cone can be highly accurately formed by the nano imprint technique. With the nano imprint technique, a desired shape, length, and a sectional shape of the conductive components 8 can be highly accurately and easily obtained by using a mold having a desired protrusion and recess pattern. Thus, the conductive components 8, which allow the contact area between the elastic electrode portion 4 and the conductive components 8 to be gently changed, can be obtained. Accordingly, the resistance between the elastic electrode portion 4 and the conductive layer 7 can be gently changed through the conductive components 8. As a result, the pressing force acting on the electrode supporting component 5 can be accurately detected.

Of course, the conductive components 8 can be formed by a technique other than the nano imprint technique. Examples of such a technique include, for example, photolithoetching and a development and removal technique. In the case of the photolithoetching, by adjusting the concentration and the flow rate of the etching liquid, the conductive components 8 having a desired shape, length, sectional shape, and so forth can be formed.

Thus, the conductive layer 7 and the plurality of conductive components 8 having conductivity can be integrated with one another so as to form the conductive structure 3. When the conductive layer 7 is not provided, the conductive components 8 are formed on the substrate 2.

Alternatively, the conductive structure 3 formed on the substrate 2 can be made as follows: that is, the liquid polymer resin material is mixed with the conductive filler elements, and the mixed liquid is poured into a mold and cured. After that, the formed part is released from the mold to produce the conductive components 8. The conductive components 8 are bonded to the substrate 2, on which the conductive layer 7 is formed.

After the conductive components 8 have been formed on the conductive layer 7 as illustrated in FIG. 20B, the spacers 6, which are formed of an insulating resin such as a polyester resin or an epoxy resin, are made at the periphery of the substrate 2 as illustrated in FIG. 20C.

As illustrated in FIG. 20D, the elastic electrode portion 4 is formed at the electrode supporting component 5 formed of, for example, a flexible plastic. When the elastic electrode portion 4 is divided into a plurality of pieces as illustrated in FIGS. 1, 6, 7, and 8, the elastic electrode portion 4 is formed as the divided pieces. Examples of the plastic that forms the electrode supporting component 5 include, for example, polyethylene terephthalate, polycarbonate, polyimide, and so forth.

In the case where the elastic electrode portion 4 illustrated in FIG. 10 is formed, a composite material, which is made by mixing the conductive filler elements 15 with the resin layer 14 formed of a liquid polymer resin material such as a silicone based resin, a styrene based resin, an acrylic resin, or a rotaxane based resin, is printed in a pattern on the electrode supporting component 5. After that, when the composite material printed in a pattern is cured, the elastic electrode portion 4 illustrated in FIG. 10 is formed. The conductive filler elements 15 are formed of a material selected from the group consisting of Au, Ag, Cu, C, ZnO, In₂O₃, SnO₂, and so forth. In order to control the elastic modulus, the tincture, and the refractive index of the elastic electrode portion 4, insulating filler may be mixed.

When the elastic electrode portion 4 illustrated in FIG. 11 is formed instead of the elastic electrode portion 4 illustrated in FIG. 10, the resin layer 16 is formed by printing the above-described polymer resin material in a pattern and curing the printed polymer resin material. The ink containing the conductive particles dispersed therein is printed in a pattern on the surface of the resin layer 16. Thus, the conductive layer 17 is formed. The conductive layer 17 can be formed by a sol-gel method or non-electrolytic plating. Alternatively, a resin material may be applied entirely to the electrode supporting component 5, and after that, the conductive layer 17 of the elastic electrode portion 4 may be formed by a technique such as photolithoetching or a development and removal technique.

Then, by providing the substrate 2 illustrated in FIG. 20C, at which the conductive layer 7, the conductive components 8, and the spacers 6 have been formed, with the electrode supporting component 5 illustrated in FIG. 20D, at which the elastic electrode portion 4 has been formed, such that the elastic electrode portion 4 opposes the conductive components 8, the pressure-sensitive element 1 illustrated in FIG. 2 is made.

Next, a method of producing the touch panel 600 that includes the pressure-sensitive element 1 according to the first embodiment of the present disclosure is described with reference to FIG. 19.

Initially, transparent conductive films 604 are formed on transparent substrates 603. Next, two transparent substrates 603, on each of which the transparent conductive film 604 has been formed, are superposed with each other. Thus, the sensor 601 that detects a touched position in the touch and 600 is made.

Next, the cover film 602 is provided on the sensor 601. Then, the pressure-sensitive element 1 is provided on the cover film 602 such that the substrate 2 is in contact with the cover film 602. As a result, the touch panel 600 including the pressure-sensitive element 1 is made.

The sensor 601 may be stacked on the pressure-sensitive element 1 on the electrode supporting component 5 side. The sensor 601 may use a sensor that detects a pressed position on a flat surface by an electrostatic capacitive method.

The pressure-sensitive element, the method of producing the pressure-sensitive element, the touch panel including the pressure-sensitive element, and the method of producing the touch panel according to the embodiments of the present disclosure have been described. However, the present disclosure is not limited to these, and it should be understood that various changes can be made by those skilled in the art without departing from the scope of the disclosure defined in the claims.

The present disclosure includes the following forms of implementation.

A pressure-sensitive element according to a form of implementation of the present disclosure includes a substrate, a conductive component, an elastic electrode portion, and an electrode supporting component. The conductive component extends from the substrate. The elastic electrode portion opposes a tip of the conductive component. The electrode supporting component opposes the substrate with the conductive component and the elastic electrode portion interposed therebetween, supports the elastic electrode portion, and has flexibility. In the pressure-sensitive element, the conductive component has a higher elastic modulus than that of the elastic electrode portion. In the pressure-sensitive element, the elastic electrode portion has a flat surface that opposes the conductive component and that is capable of being brought into contact with the conductive component.

According to the above-described form of implementation, variation of change in the resistance corresponding to a change in a pressing force can be reduced, and the durability of the pressure-sensitive element can be improved.

For example, in the pressure-sensitive element according to the above-described form of implementation, the elastic electrode portion may include a resin layer and conductive filler contained in the resin layer.

For example, in the pressure-sensitive element according to the above-described form of implementation, the elastic electrode portion may include a resin layer and a conductive layer coated on a surface of the resin layer.

For example, in the pressure-sensitive element according to the above-described form of implementation, the conductive component may include a resin component and conductive filler contained in the resin component.

For example, in the pressure-sensitive element according to the above-described form of implementation, the conductive component may include a resin component and a conductive layer coated on a surface of the resin component.

For example, in the pressure-sensitive element according to the above-described form of implementation, the conductive component may have a columnar, conical, frusto-conical, or semi-spherical shape.

For example, the pressure-sensitive element according to the above-described form of implementation may further include a conductive layer formed on the substrate. Also in the pressure-sensitive element, a plurality of the conductive components may be provided. In this case, the plurality of conductive components extend from the conductive layer on the substrate and are spaced apart from one another.

For example, in the pressure-sensitive element according to the above-described form of implementation, lengths of at least two of the plurality of conductive components from the substrate to tips of the conductive components may be different from each other.

For example, in the pressure-sensitive element according to the above-described form of implementation, when the at least two conductive components, the lengths of which from the substrate to the tips of the conductive components are different from each other, are projected in an opposing direction in which the substrate and the electrode supporting component oppose each other, a projected sectional area of a relatively long conductive component or relatively long conductive components of the at least two conductive components may be larger than a projected sectional area of a relatively short conductive component or relatively short conductive components of the at least two conductive components.

For example, in the pressure-sensitive element according to the above-described form of implementation, the conductive component may be a single component. In this case, the section of the conductive component in a direction perpendicular to an opposing direction, in which the substrate and the electrode supporting component oppose each other, is uniformly shaped, and the conductive component has a plurality of through holes penetrating therethrough in the opposing direction.

For example, in the pressure-sensitive element according to the above-described form of implementation, the conductive component may have a grid shape when seen in the opposing direction.

For example, in the pressure-sensitive element according to the above-described form of implementation, the substrate may have flexibility.

For example, in the pressure-sensitive element according to the above-described form of implementation, light in a visible range may be able to be transmitted in a direction from the substrate side to the electrode supporting component side or in a direction opposite to the direction from the substrate side to the electrode supporting component side.

A touch panel according to another form of implementation of the present disclosure includes the above-described pressure-sensitive element and a sensor that is stacked on the pressure-sensitive element and that detects a pressed position in the pressure-sensitive element when the pressure-sensitive element is pressed.

A method of producing a pressure-sensitive element according to a yet another implementation of the present disclosure includes the following steps: forming a conductive component; forming a conductive layer on a substrate; bonding the conductive layer and the conductive component to each other; providing an elastic electrode portion on an electrode supporting component; and arranging the electrode supporting component opposite the substrate such that the elastic electrode portion and the conductive component are interposed between the substrate and the electrode supporting component. In this method, the conductive component has a higher elastic modulus than that of the elastic electrode portion, and the elastic electrode portion has a flat surface that opposes the conductive component and that is capable of being brought into contact with the conductive component.

For example, in the method of producing the pressure sensitive element according to vet the other form of implementation described above, a plurality of the conductive components may be provided on the conductive layer, and lengths of at least two of the plurality of conductive components from the substrate to tips of the conductive components may be different from each other.

For example, in the method of producing the pressure sensitive element according to the yet the other form of implementation described above, when the at least two conductive components, the lengths of which from the substrate to the tips of the conductive components are different from each other, are projected in an opposing direction in which the substrate and the electrode supporting component oppose each other, a projected sectional area of a relatively long conductive component or relatively long conductive components of the at least two conductive components may be larger than a projected sectional area of a relatively short conductive component or relatively short conductive components of the at least two conductive components.

A method of producing a pressure-sensitive element according to a yet another implementation of the present disclosure includes the following steps: providing a conductive component on a substrate such that the conductive component extends from the substrate; providing an elastic electrode portion on an electrode supporting component; and arranging the electrode supporting component opposite the substrate such that the elastic electrode portion and the conductive component are interposed between the substrate and the electrode supporting component. In this method, the conductive component has a higher elastic modulus than that of the elastic electrode portion, and the elastic electrode portion has a flat surface that opposes the conductive component and that is capable of being brought into contact with the conductive component.

For example, in the method of producing the pressure sensitive element according to yet the other form of implementation described above, the conductive component may be formed by applying a polymer resin, material containing conductive filler to the substrate, forming the polymer resin material, which has been applied, by a mold having a protrusion and recess pattern, and curing the polymer resin material, which has been formed in the mold.

For example, in the method of producing the pressure-sensitive element according to yet the other form of implementation described above, the elastic electrode portion may be formed by printing a slurry, which contains an elastic resin and conductive filler dispersed in the elastic resin, in a pattern on the electrode supporting component, and curing the slurry having been printed in the pattern.

For example, in the method of producing the pressure-sensitive element according to yet the other form of implementation described above, the elastic electrode portion may be formed by printing an elastic resin in a pattern on the electrode supporting component, curing the elastic resin having been printed in the pattern on the electrode supporting component, and printing a conductive paste in a pattern on a surface of the elastic resin having been cured.

A method of producing a touch panel according to yet another form of implementation of the present disclosure includes the steps of preparing the pressure-sensitive element produced by the above-described method; making a sensor that detects a pressed position of the pressure-sensitive element when the pressure-sensitive element is pressed; and stacking the pressure-sensitive element on the sensor.

The pressure-sensitive element according to the present disclosure can be effectively utilized in touch panels of car navigation systems, smartphones, and so forth. As a result, convenience of the touch panels for the user can be improved.

What is claimed is:

1. A pressure-sensitive element comprising:
a substrate;
a conductive component that extends from the substrate;
an elastic electrode portion that opposes a tip of the conductive component; and
an electrode supporting component that opposes the substrate with the conductive component and the elastic electrode portion interposed therebetween, that supports the elastic electrode portion, and that has flexibility,
wherein the conductive component has a higher elastic modulus than that of the elastic electrode portion, and
wherein the elastic electrode portion has a flat surface which opposes and contacts the conductive component.

2. The pressure-sensitive element according to claim 1,
wherein the elastic electrode portion includes a resin layer and conductive filler contained in the resin layer.

3. The pressure-sensitive element according to claim 1,
wherein the elastic electrode portion includes a resin layer and a conductive layer coated on a surface of the resin layer.

4. The pressure-sensitive element according to claim 1,
wherein the conductive component includes a resin component and conductive filler contained in the resin component.

5. The pressure-sensitive element according to claim 1, wherein the conductive component includes a resin component and a conductive layer coated on a surface of the resin component.

6. The pressure-sensitive element according to claim 1, wherein the conductive component has a columnar, conical, frusto-conical, or semi-spherical shape.

7. The pressure-sensitive element according to claim 1, further comprising:
a conductive layer formed on the substrate,
wherein a plurality of the conductive components are provided, the plurality of conductive components extend from the conductive, layer on the substrate, and the plurality of conductive components are spaced apart from one another.

8. The pressure-sensitive element according to claim. 7,
wherein lengths of at least two of the plurality of conductive components from the substrate to the tips of the conductive components are different from each other.

9. The pressure-sensitive element according to claim 8,
wherein, when the at least two conductive components, the lengths of which from the substrate to the tips of the conductive components are different from each other, were projected in an opposing direction in which the substrate and the electrode supporting component oppose each other, a projected sectional area of a relatively long conductive component or relatively long conductive components of the at least two conductive components is larger than a projected sectional area of a relatively short conductive component or relatively short conductive components of the at least two conductive components.

10. The pressure-sensitive element according to claim 1,
wherein the conductive component is a single component, the section of the conductive component in a direction perpendicular to an opposing direction, in which the substrate and the electrode supporting component oppose each other, is uniformly shaped, and the conductive component has a plurality of through holes penetrating therethrough in the opposing direction.

11. The pressure-sensitive element according to claim 10,
wherein the conductive component has a grid shape when seen in the opposing direction.

12. The pressure-sensitive element according to claim 1,
wherein the substrate has flexibility.

13. The pressure-sensitive element according to claim 1,
wherein light in a visible range is able to be transmitted in a direction from the substrate side to the electrode supporting component side or in a direction opposite to the direction from the substrate side to the electrode supporting component side.

14. A touch panel comprising:
the pressure-sensitive element according to claim 1; and
a sensor that is stacked on the pressure-sensitive element and that detects a pressed position in the pressure-sensitive element when the pressure-sensitive element is pressed.

15. A method of producing a pressure-sensitive element, the method comprising the steps of:
providing a conductive component on a substrate such that the conductive component extends from the substrate;
providing an elastic electrode portion on an electrode supporting component; and
arranging the electrode supporting component opposite the substrate such that the elastic electrode portion and the conductive component are interposed between the substrate and the electrode supporting component,
wherein the conductive component has a higher elastic modulus than that of the elastic electrode portion, and
wherein the elastic electrode portion has a flat surface which opposes and contacts the conductive component.

16. A method of producing a pressure-sensitive element, the method comprising the steps of:
forming a conductive component;
forming a conductive layer on a substrate;
bonding the conductive layer and the conductive component to each other;
providing an elastic electrode portion on an electrode supporting component; and
arranging the electrode supporting component opposite the substrate such that the elastic electrode portion and the conductive component are interposed between the substrate and the electrode supporting component,
wherein the conductive component has a higher elastic modulus than that of the elastic electrode portion, and
wherein the elastic electrode portion has a flat surface which opposes the conductive component and which is capable of being brought into contact with the conductive component.

17. The method according to claim 16,
wherein a plurality of the conductive components are provided on the conductive layer, and
wherein lengths of at least two of the plurality of conductive components from the substrate to tips of the conductive components are different from each other.

18. The method according to claim 17,
wherein, when the at least two conductive components, the lengths of which from the substrate to the tips of the conductive components are different from each other, are projected in an opposing direction in which the substrate and the electrode supporting component oppose each other, a projected sectional area of a relatively long conductive component or relatively long conductive components of the at least two conductive components is larger than a projected sectional area of a relatively short conductive component or relatively short conductive components of the at least two conductive components.

19. The method according to claim 15,
wherein the conductive component is formed by applying a polymer resin material containing conductive filler to the substrate, forming the polymer resin material, which has been applied, by a mold having a protrusion and recess pattern, and curing the polymer resin material, which has been formed in the mold.

20. The method according to claim 15,
wherein the elastic electrode portion is formed by printing a slurry, which contains an elastic resin and conductive filler dispersed in the elastic resin, in a pattern on the electrode supporting component, and curing the slurry having been printed in the pattern.

21. The method according to claim 15,
wherein the elastic electrode portion is formed by printing an elastic resin in a pattern on the electrode supporting component, curing the elastic resin having been printed in the pattern on the electrode supporting component, and printing a conductive paste in a pattern on a surface of the elastic resin having been cured.

22. A method of producing a touch panel, the method comprising the steps of:
preparing the pressure-sensitive element produced by the method according to claim 15;
making a sensor that detects a pressed position of the pressure-sensitive element when the pressure-sensitive element is pressed; and
stacking the pressure-sensitive element on the sensor.
